(19) United States
(12) Patent Application Publication
(10) Pub. No.: US 2019/0212029 A1
(43) Pub. Date: Jul. 11, 2019

(54) HVAC REGISTER DEBRIS CONTAINMENT SYSTEM

(71) Applicant: US Mineral Products LC, Salt Lake City, UT (US)

(72) Inventor: Darrell Kirk, Salt Lake City, UT (US)

(21) Appl. No.: 16/242,771

(22) Filed: Jan. 8, 2019

Related U.S. Application Data
(60) Provisional application No. 62/614,739, filed on Jan. 8, 2018.

(51) Int. Cl. F24F 13/08; F24F 13/28; B01D 46/10

(52) U.S. Cl. CPC F24F 13/085; B01D 2279/35; B01D 46/10; F24F 13/28

(57) ABSTRACT

A register vent guard can include a body having: a housing with a top wall, at least one housing side wall, and at least one bottom wall forming a chamber, the top wall being devoid of apertures, the at least one housing side wall having a plurality of side apertures, and the at least one bottom wall defining at least one shelf and a bottom aperture; a receiver extending from the at least one bottom wall, the receiver having at least one receiver side wall with a first dimension D from the at least one bottom wall to a receiver bottom edge, the receiver forming a conduit that is fluidly coupled with the chamber; and a filter located in the chamber.

### CROSS-REFERENCE

This patent application claims priority to U.S. Provisional Application No. 62/614,739 filed Jan. 8, 2018, which provisional is incorporated herein by specific reference in its entirety.

### BACKGROUND

It is common for heating, ventilation, and air conditioning (HVAC) conduits to be placed during construction with registers opening up in a floor. As a result, once the registers are formed into a floor, which floor has a hole in it, and often there is a register in the hole along with HVAC conduits connected to the register. This opening in the floor allows for debris from additional construction to fall into the register and contaminate the HVAC conduits. When the HVAC system is turned on, the forced air blows the contamination in the conduits back out onto the floor. Often, even after cleaning and finishing a construction project, contaminated HVAC conduits can blow debris into cleaned and finished areas.

Additionally, having an open hole in a floor during construction is a hazard because workers may step into the hole and injure themselves. Also, ladders, stools, or other equipment may fall into the open hole.

A simple solution is to cover the open HVAC register holes with a board or other material to form a barrier. However, this does not allow for the HVAC system to operate because the air flow is inhibited by the barrier. One reason HVAC systems can be installed early in construction processes is to provide heat during winter months or cooling during summer months or ventilation at any time after installation. However, the barrier prevents proper operation of the HVAC system.

Therefore, it would be advantageous to have a custom HVAC register barrier that inhibits contamination of the HVAC conduits and allows for operation of the HVAC system.

### SUMMARY

In some embodiments, a register vent guard can include: a body having: a housing with a top wall, at least one housing side wall, and at least one bottom wall forming a chamber, the top wall being devoid of apertures, the at least one housing side wall having a plurality of side apertures, and the at least one bottom wall defining at least one shelf and a bottom aperture; and a receiver extending from the at least one bottom wall, the receiver having at least one receiver side wall with a first dimension D from the at least one bottom wall to a receiver bottom edge, the receiver forming a conduit that is fluidly coupled with the chamber; and a filter located in the chamber.

In some embodiments, a method of making the register vent guard of one of the embodiments can include: providing a flat member; cutting the flat member to have the shape of one of the embodiments with the side apertures formed therein; bending the flat member at a plurality of bend locations to form the register vent guard.

In some embodiments, a method of using the register vent guard to inhibit contamination of a register can include: providing the register vent guard of one of the embodiments; and inserting the register vent guard into a register.

In some embodiments, a register vent guard kit can include a register vent guard in accordance with one of the embodiments, and at least one filter that is configured to be located in the chamber.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIGS. 1A-1E show different views of an embodiment of a register vent guard.

FIG. 1F shows a portion of a corner of an embodiment of the register vent guard.

FIG. 1G shows an embodiment of a filter for use in the register vent guard.

FIGS. 2A-2D show different views of an embodiment of a register vent guard and relevant dimensions thereof.

FIGS. 3A-3D show different views of an embodiment of a register vent guard and relevant dimensions thereof.

FIG. 4 shows an embodiment of a flat member cutout so that bending steps can be performed to form the register vent guard.

FIGS. 5A-5C show alternate shapes and embodiments of the register vent guard.

The subject matter of the figures can be arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present technology relates to a register vent guard that can protect a vent of an installed floor register. Previously, once the heating and/or cooling system ducts have been installed in a building and the registers are in the floors with the register vents facing upwards, constructing or cleaning activities can cause debris to fall into the register vents. Such debris can contaminate the ducts and conduits, which is unfavorable in view of the ducts and conduits delivering air (e.g., breathing air). Accordingly, it can be advantageous to inhibit debris from entering a register vent. Heretofore, it has been common to place a flat member, such as sheet metal, over the register vent, and optionally to use screws or nails to fasten the flat member to the floor. However, when not secured, the sheet metal can move, and when secured, the floor has to be fixed due to the holes left by the screws or nails. Also, the sheet metal often is not strong enough to support the weight of a worker and/or a ladder, and falling through the sheet metal and damaging the register or injuring the working or other equipment can occur. Now, the present register vent guard can be outfitted with a filter in its internal chamber, and placed into a register vent in order to inhibit debris from contaminating the register.

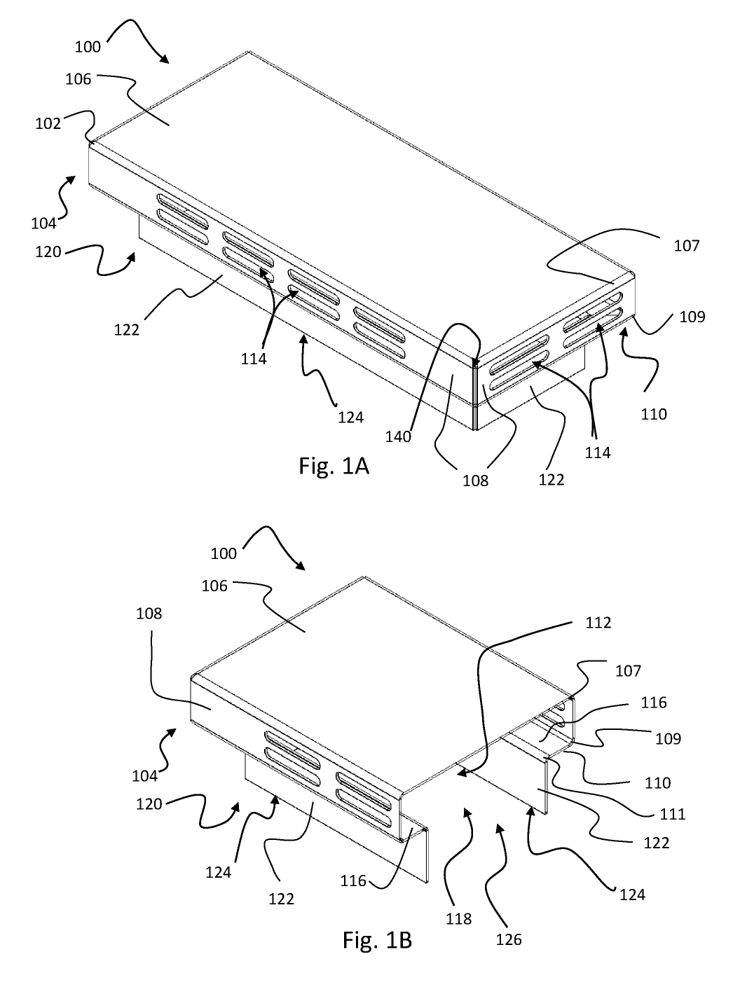

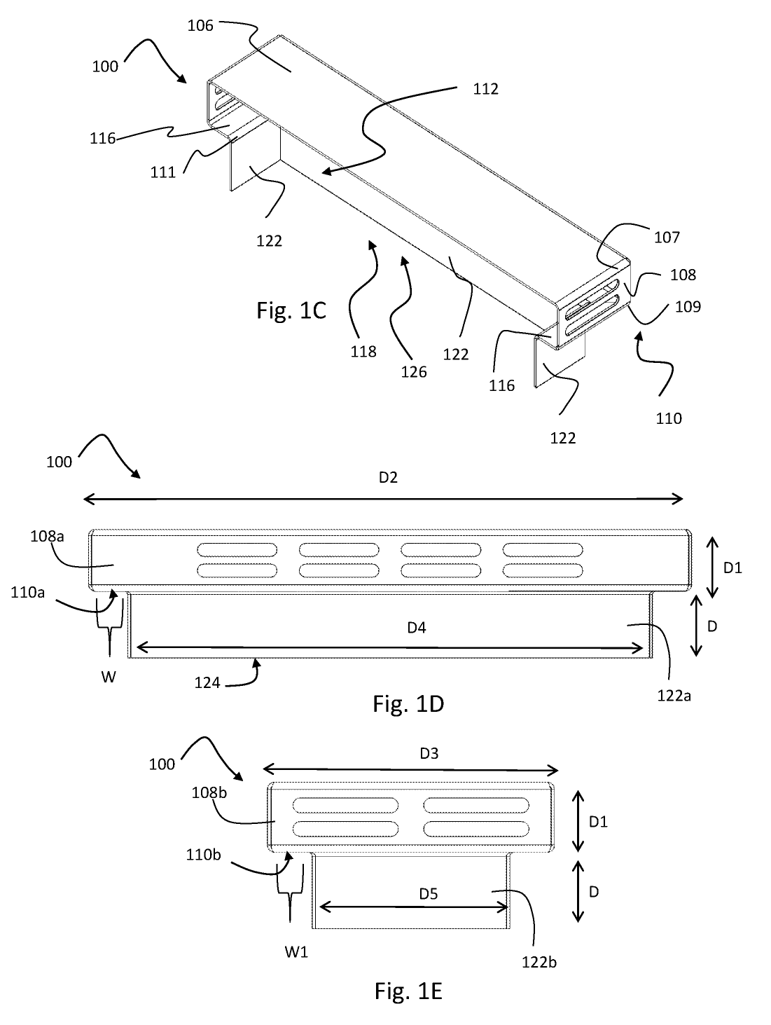

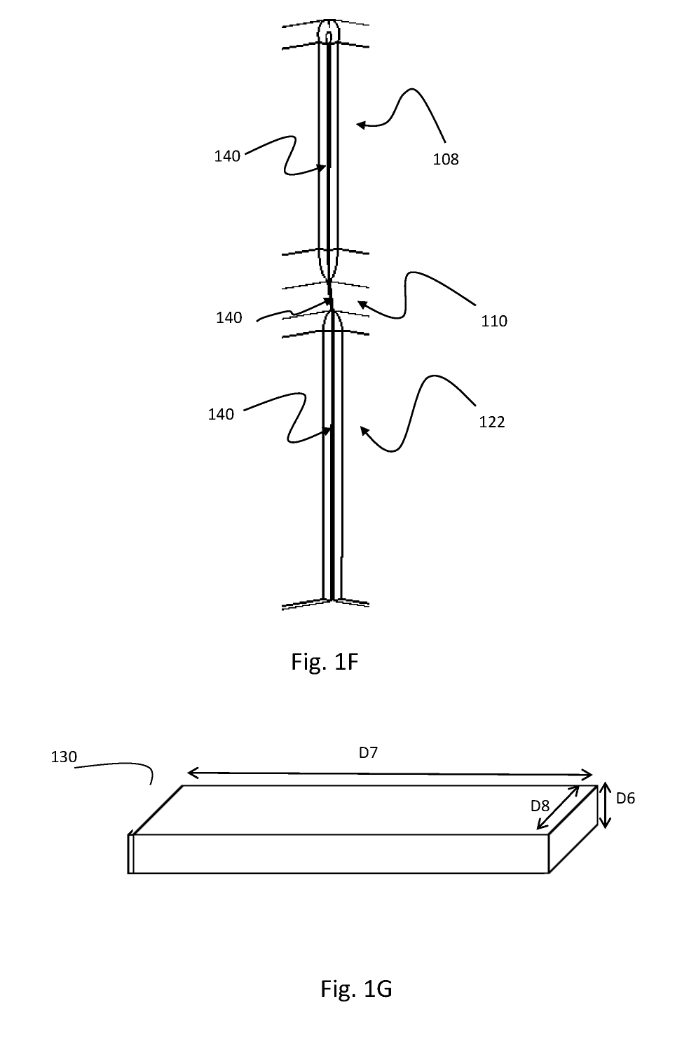

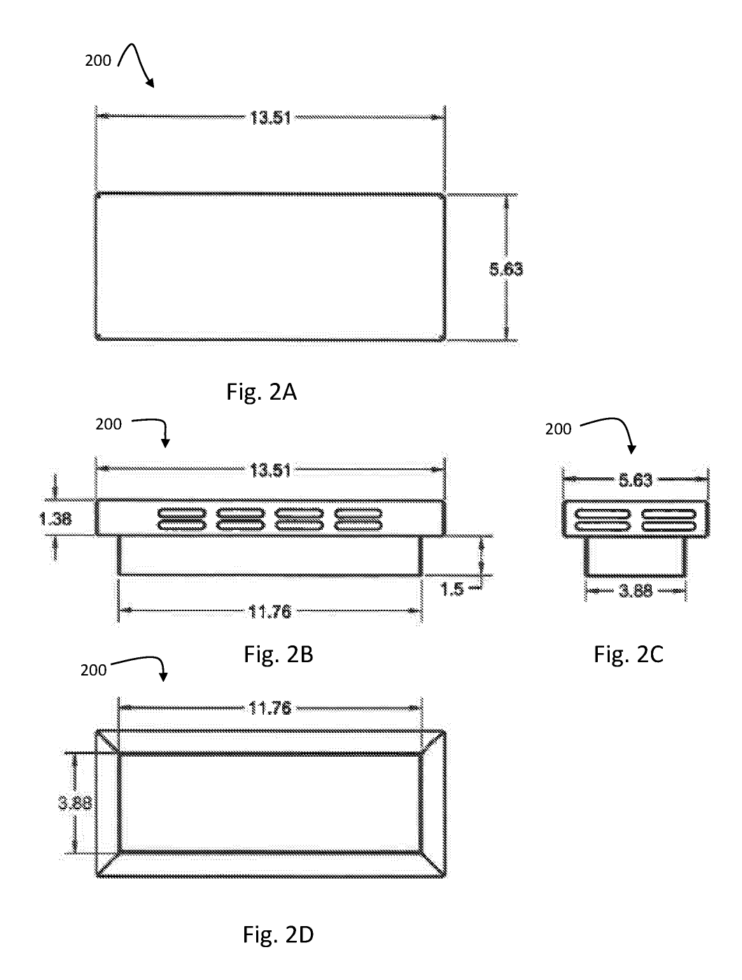

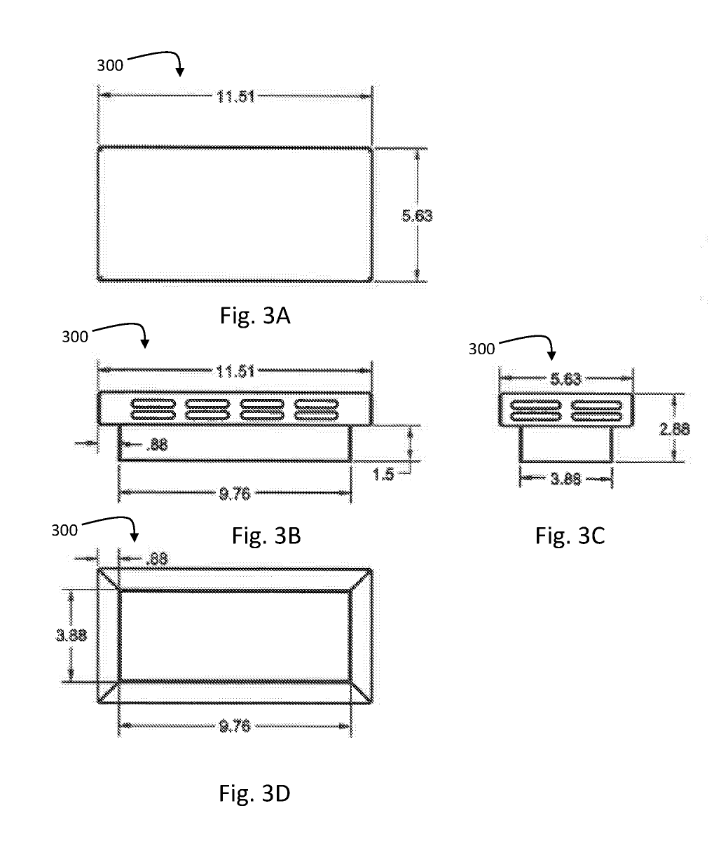

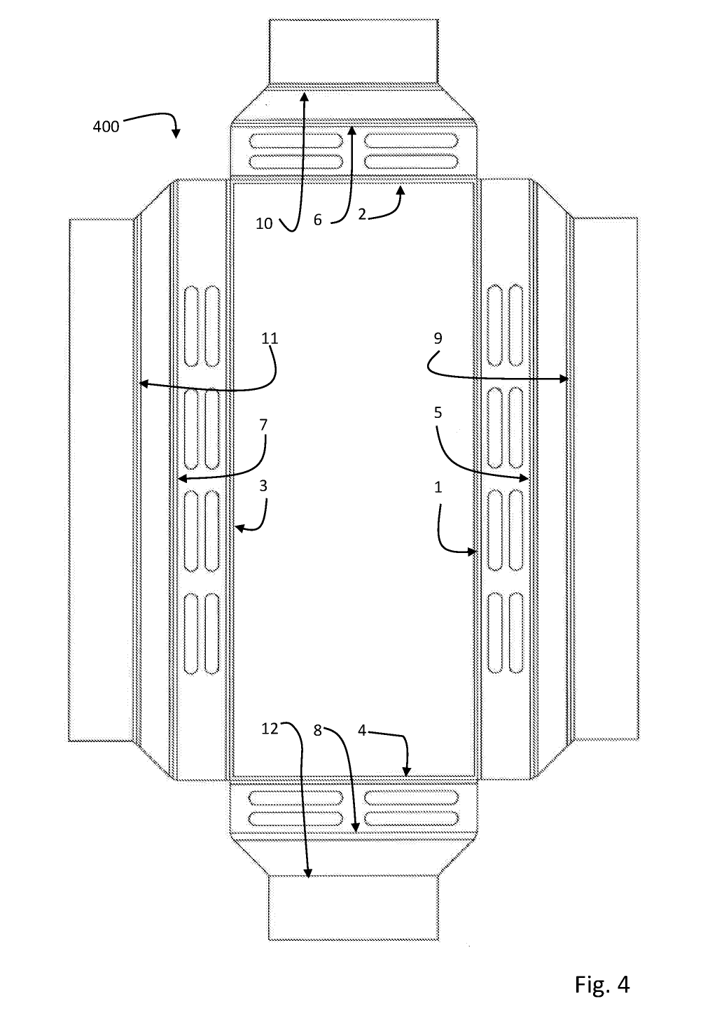

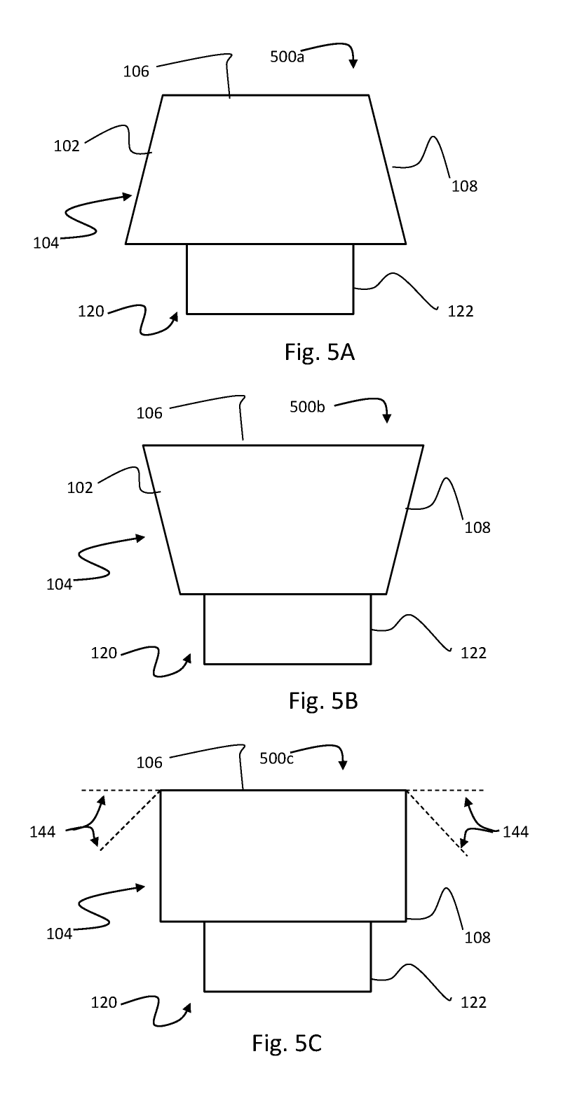

FIGS. 1A-1E show different views of the register vent guard 100. FIG. 1F shows a portion of a corner of the register vent guard 100. FIG. 1G shows a filter 130 for use in the register vent guard. FIGS. 2A-2D show different views of a register vent guard 200 and relevant dimensions thereof. FIGS. 3A-3D show different views of a register vent guard 300 and relevant dimensions thereof. FIG. 4 shows a flat member cutout so that bending steps can be performed to form the register vent guard. FIGS. 5A-5C show alternate shapes and embodiments of the register vent guard.

FIG. 1A shows a perspective view, FIG. 1B shows a cross-sectioned view, FIG. 1C shows another cross-sectioned view, FIG. 1D shows a side view, and FIG. 1E shows an end view. A register vent guard 100 is shown to include a body 102 having a housing 104 and a receiver 120. The body 102 can be unitary so that the housing 104 and receiver 120 are made of the same material as a single piece. However, the housing 104 and receiver 120 may be separate pieces that are coupled together, such as through welding, brazing, or fastening (e.g., screws, bolts, nuts, adhesive, etc.). The body 102 can be formed of a metal material, such as 16 gauge or 18 gauge, or of a plastic, such as a hard plastic that is impact or shatter proof.

The body 102 can have a housing 104 with a top wall 106, at least one housing side wall 108 (e.g., 1, 2, 3, or 4 side walls 108), and at least one bottom wall 110 (e.g., 1, 2, 3, or 4 bottom walls 110) forming a chamber 112. The top wall 106 is devoid of apertures, and thereby debris is inhibited from falling into the register vent guard or into a register vent being protected from debris. The at least one housing side wall 108 has a plurality of side apertures 114 as shown. These apertures 114 allow for air to be blown out of the register without being inhibited or degrading the heating and/or cooling potential of an HVAC system (heating, ventilation, and air conditioning system). The at least one bottom wall 110 defines at least one shelf 116 and a bottom aperture 118. The bottom aperture 118 can be formed by the space between each of the at least one bottom wall 110. As provided, four bottom walls 110 are provided that cooperatively form the shelf 116 or shelves that hold the filter in the chamber 112. A filter 130 (FIG. 1G) can be removably located in the chamber 112.

The body 102 can have a receiver 120 extending from the at least one bottom wall 110 of the housing 104. The receiver 120 has at least one receiver side wall 122 (e.g., 1, 2, 3, or 4 receiver side walls 122) with a first dimension D from the at least one bottom wall 110 to a receiver bottom edge 124. The least one receiver side wall 122 of the receiver 120 forms a conduit 126 that is fluidly coupled with the chamber 112.

In one embodiment, the register vent guard 100 has a body 102 that includes one or more of: four housing side walls 108; four bottom walls 110; or four receiver side walls 122. In one embodiment, the top wall 106 is connected to each housing side wall 108. In one aspect, the top wall 106 is connected to each housing side wall 108 through a bend 107. In one embodiment, each housing side wall 108 is connected to a bottom wall 110. In one aspect, each housing side wall 108 is connected to a bottom wall 110 through a bend 109. In one embodiment, each bottom wall 110 is connected to a receiver side wall 122. In one aspect, each bottom wall 110 is connected to a receiver side wall 122 through a bend 111.

As described herein, the register vent guard 100 can be formed by shaping a flat member and then bending that shaped flat member into the shape of the register vent guard 100. This can result in a gap 140 (FIG. 1F) between adjacent housing side walls 108 such that the housing side walls 108 are separate from each other. This can also result in a gap 140 between adjacent receiver side walls 122 such that the receiver side walls 122 are separate from each other. In one aspect, a gap 140 extends between adjacent housing side walls 108, adjacent bottom walls 110, and adjacent receiver side walls 122. However, the register vent guard 100 can be configured with a junction (e.g., a joint or joining member or joining feature) between adjacent housing side walls 108 such that the housing side walls 108 are joined together. Similarly, a junction can be located between adjacent receiver side walls 122 such that the receiver side walls 122 are joined together. Additionally, a gap 140 can be located between adjacent bottom walls 110 such that the bottom walls 110 are separate from each other. Also, a junction can be between adjacent bottom walls 110 such that the bottom walls 110 are joined together. In one aspect, a junction between adjacent walls can include a weld, braze, a bend, a corner member, junction member, junction flap, or combinations thereof.

In one embodiment, the register vent guard 100 can include an interface between adjacent housing side walls 108 such that the housing side walls 108 are touching, but not physically joined or coupled together. The interface allows for the gap and flexing during heating or cooling to accommodate thermal expansion and contraction. The register vent guard 100 can also include an interface between adjacent receiver side walls 122 such that the receiver side walls 122 are touching. Additionally, the register vent guard 100 can include an interface between adjacent bottom walls 110 such that the bottom walls 110 are touching.

The plurality of side apertures 114 can be any shape, such as the elongated shape shown, circles, squares, rectangles, polygons, irregular shapes, or combinations thereof. The side apertures 114 may be in any arrangement or distribution, whether in a single row at the bottom or at the top, or two rows as shown. The side apertures 114 can have a dimension, such as a diameter or short dimension that is smaller than common debris in order to keep such debris out. However, any debris that passes through a side aperture 114 can be caught and retained by the filter 130. The register vent guard 100 can include the plurality of side apertures 114 having a combined cross-sectional profile area that is approximately the same as a cross-sectional profile area of the bottom aperture 118. As such, the air flowing from the register out of the vent can also pass out of the side apertures 114 without a reduction in flow or substantially inhibiting the flow. Matching the total area of the side apertures 114 with the total area of the bottom aperture 118 can create optimal air flow out of the register vent guard 100. In one aspect, the plurality of side apertures 114 have a combined cross-sectional profile area that is larger than a cross-sectional profile area of the bottom aperture 118. In one aspect, the plurality of side apertures 114 have a combined cross-sectional profile area that is smaller than a cross-sectional profile area of the bottom aperture 118. In one aspect, the plurality of side apertures 114 have a combined cross-sectional profile area that is approximately the same as or within +/−1%, 2%, 5%, 10%, 20%, or 25% of a cross-sectional profile area of the bottom aperture 118. In one aspect, the conduit 126 has a cross-sectional profile that is approximately the same as or within +/−1%, 2%, 5%, 10%, 20%, or 25% of a cross-sectional profile area of the bottom aperture 118.

The register vent guard 100 can be custom shaped and sized for any register vent. However, the register vent guard 100, such as the receiver 120 may be formed into common register vent shapes and sizes, such as those illustrated and described herein. As shown in FIGS. 1D and 1E, the various body portions can have different dimensions, such as D, D1, D2, D3, D4, D5, W, and W1. In one aspect, each housing side wall has a dimension D1. In one aspect, each housing side wall has a dimension D1 that is larger than dimension D. In one aspect, each housing side wall has a dimension D1 that is smaller than dimension D. In one aspect, each housing side wall has a dimension D1 that is about the same as dimension D. In one aspect, each end bottom wall 110a has a dimension W. In one aspect, each side bottom wall 110b has a dimension W1. In one aspect, each end bottom wall 110a has a dimension W and each side bottom wall 110b has a dimension W1, wherein dimension W is larger, smaller, or about the same as dimension W1.

As shown in FIG. 1G, the filter has a height with dimension D6. In one aspect, the filter has a height with dimension D6 that is the larger, smaller, or about the same as dimension D1. Also, the filter 130 has a cross-sectional profile with a long dimension D7 and a short dimension D8 and has a height having dimension D6. In one aspect, the filter 130 has at least one of the following: a long dimension D7 the same as or shorter than dimension D2; a short dimension D8 the same as or shorter than dimension D3; and a height having dimension D6 the same or shorter then dimension D1. In one aspect, the filter 130 has at least one of the following: a long dimension D7 longer than dimension D4; or a short dimension D8 longer than dimension D5. The filter 130 can be any type of filter, such as any filter used in a HVAC system. In one aspect, the filter 130 is a mesh filter.

In one embodiment, at least one of the top wall 106, side wall 108, receiver side wall 122, bottom aperture 118, conduit 126, or chamber 112 has a rectangular shape. In one aspect, the register vent guard 100 has at least one of the following: the top wall 106 has a long dimension D2 and a short dimension D3; a long side wall 108a has the long dimension D2 and a short dimension D1; a short side wall 108b has the long dimension D3 and a short dimension D1; a long receiver side wall 122a has the long dimension D4 and a short dimension D; or a short receiver side wall 122b has the long dimension D5 and a short dimension D. In one aspect, the register vent guard 100 has at least one of the following: the chamber 112 has a cross-sectional profile with a long dimension D2 and a short dimension D3 and has a height having dimension D1; the bottom aperture 118 has a long dimension D4 and a short dimension D5; or the conduit 126 has a cross-sectional profile with a long dimension D4 and a short dimension D5 and has a height having dimension D.

As described, the register vent guard 100 can have various shapes. In one aspect, the housing 104 has a longitudinal axis aligned with a longitudinal axis of the conduit 126, wherein the housing has a lateral cross-sectional profile that is orthogonal with the longitudinal axis, the lateral cross-sectional profile being square, rectangular, circular, oval, or other polygon. In one aspect, the housing 104 has a longitudinal axis aligned with a longitudinal axis of the conduit 126, wherein the housing has a longitudinal cross-sectional profile that is parallel with the longitudinal axis, the longitudinal cross-sectional profile being square, rectangular (see FIGS. 1A-1E), trapezoidal (see FIG. 5A for register vent guard 500a and FIG. 5B for register vent guard 500b), circular, oval, or other polygon.

As shown in FIG. 5C, the register vent guard 500c includes an overhang 144 from the top wall 106 relative to the at least one housing side wall 108. In one example, the overhang 144 is parallel with the top wall 106. In another example, the overhang 144 is non-parallel (e.g., it is at an angle between 0 and 90 degrees) with the top wall 106. The overhang 144 can be fixed and not rotatable. However, the overhang 144 may be rotatable relative to the housing side wall 108. The register vent guard 500c may include a plurality of overhangs 144, such as one for each side aperture 114.

In one embodiment, the at least one shelf 116 is adapted to hold the filter 130. In one aspect, the filter 130 is self-supporting. In one aspect, the at least one shelf 116 forms a perimeter shelf around the bottom aperture 118. In one aspect, the dimension D of the at least one receiver side wall 122 is of a length sufficient to inhibit the receiver 120 from lifting from an air conduit register.

As described herein, the register vent guard can have various shapes and sizes. In one example shown in FIGS. 2A-2D, the register vent guard 200 is configured as follows: D is about 1 inch to about 6 inches, about 1.1 inches to about 4 inches, about 1.25 inches to about 2 inches, or about 1.5 inches to about 1.75 inches; D1 is about 1 inch to about 6 inches, about 1.1 inches to about 4 inches, about 1.25 inches to about 2 inches, or about 1.4 inches to about 1.75 inches; D2 is about 10 inches to about 20 inches, about 12 inches to about 18 inches, about 13 inches to about 15 inches, or about 13.5 inches to about 14 inches; D3 is about 3 inches to about 8 inches, about 4 inches to about 7 inches, about 4 inches to about 6 inches, or about 5.5 inches; D4 is about 6 inches to about 18 inches, about 8 inches to about 16 inches, about 10 inches to about 15 inches, about 11 inches to about 12 inches; D5 is about 1 inches to about 7 inches, about 2 inches to about 6 inches, about 3 inches to about 4 inches, or about 3.75 inches; W is about 0.25 inches to about 1.5 inches, about 0.5 inches to about 1.25 inches, about 0.75 inches to about 1 inches, or about 0.85 inches; and/or W1 is about 0.25 inches to about 1.5 inches, about 0.5 inches to about 1.25 inches, about 0.75 inches to about 1 inches, or about 0.85 inches.

As described herein, the register vent guard can have various shapes and sizes. In one example shown in FIGS. 2A-2D, the register vent guard 200 is configured as follows: D is about 1.5 inches; D1 is about 1.38 inches; D2 is about 13.51 inches; D3 is about 5.63 inches; D4 is about 11.76 inches; D5 is about 3.88 inches; W is about 0.875 inches; and/or W1 is about 0.875 inches. In one example shown in FIGS. 3A-3D, the register vent guard 200 is configured as follows: D is about 1.5 inches; D1 is about 1.38 inches; D2 is about 11.51 inches; D3 is about 5.63 inches; D4 is about 9.76 inches; D5 is about 3.88 inches; W is about 0.875 inches; and/or W1 is about 0.875 inches. Any of these values can be or within +/−1%, 2%, 5%, 10%, 20%, or 25% thereof.

In one example shown in FIGS. 3A-3D, the register vent guard 200 is configured as follows: D is about 1.5 inches, or within +/−1%, 2%, 5%, 10%, 20%, or 25% thereof; D1 is about 1.38 inches, or within +/−1%, 2%, 5%, 10%, 20%, or 25%; D2 is about 11.51 inches, or within +/−1%, 2%, 5%, 10%, 20%, or 25%; D3 is about 5.63 inches, or within +/−1%, 2%, 5%, 10%, 20%, or 25%; D4 is about 9.76 inches, or within +/−1%, 2%, 5%, 10%, 20%, or 25%; D5 is about 3.88 inches, or within +/−1%, 2%, 5%, 10%, 20%, or 25%; W is about 0.875 inches, or within +/−1%, 2%, 5%, 10%, 20%, or 25%; and/or W1 is about 0.875 inches, or within +/−1%, 2%, 5%, 10%, 20%, or 25%.

The register vent guard may be a single piece or multiple pieces fastened together. In one aspect, the body 102 is a unitary member. In one aspect, at least some of the walls are joined by bends. In one aspect, the register vent guard 100 is devoid of a weld or braze.

In one embodiment, a method 400 of making the register vent guard in accordance with one of the embodiments is provided. Such a method can include providing a flat member. The method can then include cutting the flat member to have the shape of FIG. 4, or using some method to form such a shape. The sections between the walls are formed by bending. As such, the method 400 can include bending the flat member of FIG. 4 at a plurality of bend locations to form the register vent guard 100 of FIGS. 1A-1E.

FIG. 4 shows an embodiment of method of forming a register vent guard, which can be formed by selective bending as described herein. The register vent guard can be formed by providing a flat member; and shaping the flat member to have the shape of FIG. 4. Then, the method 400 can include bending the flat member on a plurality of bend locations to form the register vent guard, the bending being in any order in accordance with: forming bend 12 by bending up; forming bend 11 by bending up; forming bend 10 by bending up; forming bend 9 by bending up; forming bend 8 by bending down; forming bend 7 by bending down; forming bend 6 by bending down; forming bend 5 by bending down; forming bend 4 by bending down; forming bend 3 by bending down; forming bend 2 by bending down; and forming bend 1 by bending down. Alternatively, the method 400 can include bending the flat member on a plurality of bend locations to form the register vent guard, the bending being in any order in accordance with: forming bend 12 by bending down; forming bend 11 by bending down; forming bend 10 by bending down; forming bend 9 by bending down; forming bend 8 by bending up; forming bend 7 by bending up; forming bend 6 by bending up; forming bend 5 by bending up; forming bend 4 by bending up; forming bend 3 by bending up; forming bend 2 by bending up; and forming bend 1 by bending up. In one aspect, each bend has a bend radius of about 0.8 inches, or within +/−1%, 2%, 5%, 10%, 20%, or 25% thereof. In one aspect, each bend is about 90 degrees. In one aspect, the shaping is by at least one of: laser cutting; stamping; machine cutting; flow cutting; laser cutting; sandblasting cutting; or combination thereof.

In one embodiment, a method of using the register vent guard to inhibit contamination of a register is provided. The method can include: providing the register vent guard 100 of one of the embodiments; and inserting the register vent guard 100 into a register. In one aspect, the register is part of a ventilation conduit. In one aspect, the register is in a floor of a building such that the register vent guard is set down into register by the receiver side walls sliding into the register. In one aspect, the register is part of a heating and/or cooling ventilation system. In one aspect, the register is in a building undergoing construction. In one aspect, the register has a dimension to receive the receiver 120. In one aspect, the method can include performing a construction activity (e.g., painting, sweeping, dusting, drywalling, mudding) while the register vent guard 100 is in the register. In one aspect, the method can include performing a cleaning activity while the register vent guard 100 is in the register. In one aspect, the method can include performing a painting, sweeping, dusting, drywalling, mudding, or other activity in a room while the register vent guard 100 is in the register in the room.

In one embodiment, a register vent guard kit is provided. The register vent guard kit can include a register vent guard in accordance with one of the embodiments, such as 100. The register vent guard 100 can include a body 102 having: a housing 104 with a top wall 106, at least one housing side wall 108, and at least one bottom wall 110 forming a chamber 112, the top wall 106 being devoid of apertures, the at least one housing side wall 108 having a plurality of side apertures 114, and the at least one bottom wall 110 defining at least one shelf 116 and a bottom aperture 118; and a receiver 120 extending from the at least one bottom wall 110, the receiver 120 having at least one receiver side wall 122 with a first dimension D from the at last one bottom wall 110 to a receiver bottom edge 124, the receiver 120 forming a conduit 126 that is fluidly coupled with the chamber 112. The kit can also include a filter 130 configured to be located in the chamber 112. In one aspect, the kit includes the filter 130 being packaged with the register vent guard 100. In one aspect, the kit includes the filter 130 being located outside of the chamber 112. In one aspect, the kit can include a plurality of filters 130. In one aspect, the kit can include a plurality of register vent guards.

In one embodiment, the register vent guard can be used to protect a register vent from debris during construction. Use of the register vent guard can prevent having to try to get all the dry wall, wood shavings, wire, paint, overspray, or other debris out of the register (e.g., heat vents) for any reason, such as during finishing, because the debris has been blocked. Additionally, the register vent guard can provide a safety feature so the workers do not step down into the open vent holes in the floor during construction. The register vent guard can also inhibit ladders and tools from from falling down into the floor register vents. The register vent guard includes the side apertures so that the HVAC system can be operated during constructions, such as to provide heat in the winter or cooling in the summer. The side apertures and filter keeps dust and other debris out of the register, but still allows the register to operate for the HVAC system. As such, the register vent guard allows for operating the HVAC system during construction while keeping debris out of the register. Selection of a hard material, such as 16-20 gauge allows for the register vent guard to be reusable.

The filter can be any type of HVAC filter, such as a standard air flow mesh filter, sponge filter, porous member, screen, screen having small screen aperture size, or any type of filter. The filter may be metal or plastic. In some examples, the filter material may be fiberglass, Nylon, or recyclable material. In one aspect, the filter is washable. The filter is configured to stop debris, but allow air flow. The filter cleans itself when the HVAC blower is on to blow dust and particles out of the side wall apertures.

The receiver is dimensioned to go down into the boot of a register (e.g., fit into the register vent opening). The bottom wall can set on the plywood or other flooring material around the register to make it stable, and to seal the vent hole. The receiver of the register vent cover will fit in the register vent, and it will stay in there sitting down flush on the floor. This can allow workers to perform construction or cleaning activities without debris going into the register. The register vent guard can inhibit debris when workers are sweeping, moving, sanding, painting, drywalling, mudding, or performing other activities.

The side apertures collectively have an area for fluid flow therethrough that is about the same calculated amount of flow through the register vent. This allows for normal operation of the HVAC system while the register vent guard is installed. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In order to increase safety, the register vent guard can include a bright or visible color, such as yellow, or caution marking to draw attention. The register vent guard may also have indicia or logos. The edges or bends or corners may include padding or bumpers to increase safety.

In some embodiments, a register vent guard can include: a body having: a housing with a top wall, at least one housing side wall, and at least one bottom wall forming a chamber, the top wall being devoid of apertures, the at least one housing side wall having a plurality of side apertures, and the at least one bottom wall defining at least one shelf and a bottom aperture; and a receiver extending from the at least one bottom wall, the receiver having at least one receiver side wall with a first dimension D from the at least one bottom wall to a receiver bottom edge, the receiver forming a conduit that is fluidly coupled with the chamber; and a filter located in the chamber. In some aspects, the body includes four housing side walls. In some aspects, the body includes four bottom walls. In some aspects, the top wall is connected to each housing side wall. In some aspects, the top wall is connected to each housing side wall through a bend. In some aspects, each housing side wall is connected to a bottom wall. In some aspects, each housing side wall is connected to a bottom wall through a bend. In some aspects, each bottom wall is connected to a receiver side wall. In some aspects, each bottom wall is connected to a receiver side wall through a bend.

In some embodiments, a gap is located between adjacent housing side walls such that the housing side walls are separate from each other. In some aspects, the gap is between adjacent receiver side walls such that the receiver side walls are separate from each other. In some aspects, instead of a gap, a junction is between adjacent housing side walls such that the housing side walls are joined together. In some aspects, the junction between adjacent receiver side walls such that the receiver side walls are joined together. In some aspects, a gap is between adjacent bottom walls such that the bottom walls are separate from each other. In some aspects, there is a junction between adjacent bottom walls such that the bottom walls are joined together. In some aspects, the junction between adjacent walls includes a weld, braze, a bend, a corner member, or combinations thereof. In some aspects, the gap extends between adjacent housing side walls, adjacent bottom walls, and adjacent receiver side walls. In some aspects, there is an interface between adjacent housing side walls such that the housing side walls are touching. In some aspects, the interface is between adjacent receiver side walls such that the receiver side walls are touching. In some aspects, the interface is between adjacent bottom walls such that the bottom walls are touching.

In some embodiments, the register vent guard has a plurality of side apertures that have a combined cross-sectional profile area that is approximately the same as a cross-sectional profile area of the bottom aperture. In some aspects, the plurality of side apertures have a combined cross-sectional profile area that is larger than a cross-sectional profile area of the bottom aperture. In some aspects, the plurality of side apertures have a combined cross-sectional profile area that is smaller than a cross-sectional profile area of the bottom aperture. In some aspects, the plurality of side apertures have a combined cross-sectional profile area that is approximately the same as or within +/−1%, 2%, 5%, 10%, 20%, or 25% of a cross-sectional profile area of the bottom aperture. In some aspects, the conduit has a cross-sectional profile that is approximately the same as or within +/−1%, 2%, 5%, 10%, 20%, or 25% of a cross-sectional profile area of the bottom aperture.

In some embodiments, the features of the housing can have various dimensions. In some aspects, each housing side wall has a dimension D1. In some aspects, each housing side wall has a dimension D1 that is larger than dimension D. In some aspects, each housing side wall has a dimension D1 that is smaller than dimension D. In some aspects, each housing side wall has a dimension D1 that is about the same as dimension D. In some aspects, each end bottom wall has a dimension W. In some aspects, each side bottom wall has a dimension W1. In some aspects, each end bottom wall has a dimension W and each side bottom wall has a dimension W1, wherein dimension W is larger, smaller, or about the same as dimension W1. In some aspects, the filter has a height with dimension D6. In some aspects, the filter has a height with dimension D6 that is the larger, smaller, or about the same a dimension D1. In some aspects, at least one of the top wall, side wall, receiver side wall, bottom aperture, conduit, or chamber has a rectangular shape.

In some embodiments, the register vent guard has at least one of the following: the top wall has a long dimension D2 and a short dimension D3; a long side wall has the long dimension D2 and a short dimension D1; a short side wall has the long dimension D3 and a short dimension D1; a long receiver side wall has the long dimension D4 and a short dimension D; or a short receiver side wall has the long dimension D5 and a short dimension D.

In some embodiments, the register vent guard has at least one of the following: the chamber has a cross-sectional profile with a long dimension D2 and a short dimension D3 and has a height having dimension D1; the bottom aperture has a long dimension D4 and a short dimension D5; or the conduit has a cross-sectional profile with a long dimension D4 and a short dimension D5 and has a height having dimension D.

In some embodiments, the filter has at least one of the following: the filter has a cross-sectional profile with a long dimension D7 and a short dimension D8 and has a height having dimension D6. In some aspects, the filter has at least one of the following: a long dimension D7 the same as or shorter than dimension D2; a short dimension D8 the same as or shorter than dimension D3; and/or a height having dimension D6 the same or shorter then dimension D1. In some aspects, the filter has at least one of the following: a long dimension D7 longer than dimension D4; and/or a short dimension D8 longer than dimension D5. In some aspects, the filter is a mesh filter.

In some embodiments, the housing has a longitudinal axis aligned with a longitudinal axis of the conduit, wherein the housing has a lateral cross-sectional profile that is orthogonal with the longitudinal axis, the lateral cross-sectional profile being square, rectangular, circular, oval, or other polygon. In some aspects, the housing has a longitudinal axis aligned with a longitudinal axis of the conduit, wherein the housing has a longitudinal cross-sectional profile that is parallel with the longitudinal axis, the longitudinal cross-sectional profile being square, rectangular, trapezoidal, circular, oval, or other polygon.

In some embodiments, the register vent guard includes an overhang from the top wall relative to the at least one housing side wall. In some aspects, the overhang is from the top wall relative to the at least one housing side wall, the overhang being parallel with the top wall. In some aspects, the overhang is from the top wall relative to the at least one housing side wall, the overhang being non-parallel with the top wall.

In some embodiments, the at least one shelf is adapted to hold the filter. In some aspects, the filter is self-supporting. In some aspects, the at least one shelf forms a perimeter shelf around the bottom aperture. In some aspects, the dimension D of the at least one receiver side wall is of a length sufficient to inhibit the receiver from lifting from an air conduit register.

In one embodiment, the register vent guard includes at least one of the following: D is about 1.5 inches; D1 is about 1.38 inches; D2 is about 13.51 inches; D3 is about 5.63 inches; D4 is about 11.76 inches; D5 is about 3.88 inches; W is about 0.875 inches; and/or W1 is about 0.875 inches, or within +/−1%, 2%, 5%, 10%, 20%, or 25% thereof.

In one embodiment, the register vent guard includes at least one of the following: D is about 1.5 inches; D1 is about 1.38 inches; D2 is about 11.51 inches; D3 is about 5.63 inches; D4 is about 9.76 inches; D5 is about 3.88 inches; W is about 0.875 inches; and/or W1 is about 0.875 inches.

In some embodiments, the body is a unitary member. In other embodiments, each body panel may be a different member, which are coupled together. In some aspects, the walls are joined by bends. In some aspects, the gaps are devoid of a weld or braze. In some aspects, the register vent cover is devoid of a weld or braze.

In some embodiments, a method of making the register vent guard of one of the embodiments can include: providing a flat member; cutting the flat member to have the shape of one of the embodiments with the side apertures formed therein (see FIG. 4); bending the flat member at a plurality of bend locations to form the register vent guard.

In some embodiments the method of making the register vent guard can include: providing a flat member; shaping the flat member to have the shape of FIG. 4; bending the flat member on a plurality of bend locations to form the register vent guard, the bending being in any order in accordance with: forming bend 12 by bending up; forming bend 11 by bending up; forming bend 10 by bending up; forming bend 9 by bending up; forming bend 8 by bending down; forming bend 7 by bending down; forming bend 6 by bending down; forming bend 5 by bending down; forming bend 4 by bending down; forming bend 3 by bending down; forming bend 2 by bending down; and forming bend 1 by bending down.

In some embodiments the method of making the register vent guard can include: providing a flat member; shaping the flat member to have the shape of FIG. 4; bending the flat member on a plurality of bend locations to form the register vent guard, the bending being in any order in accordance with: forming bend 12 by bending down; forming bend 11 by bending down; forming bend 10 by bending down; forming bend 9 by bending down; forming bend 8 by bending up; forming bend 7 by bending up; forming bend 6 by bending up; forming bend 5 by bending up; forming bend 4 by bending up; forming bend 3 by bending up; forming bend 2 by bending up; and forming bend 1 by bending up. In some aspects, each bend has a bend radius of about 0.8 inches. In some aspects, each bend is about 90 degrees. In some aspects, the shaping is by at least one of: laser cutting; stamping; machine cutting; flow cutting; laser cutting; sandblasting cutting; or combination thereof.

In one embodiment, a method of using the register vent guard to inhibit contamination of a register can include: providing the register vent guard of one of the embodiments; and inserting the register vent guard into a register. In some aspects, the register is part of a ventilation conduit. In some aspects, the register is in a floor of a building such that the register vent guard is set down into register by the receiver side walls sliding into the register. In some aspects, the register is part of a heating and/or cooling ventilation system. In some aspects, the register is in a building undergoing construction. In some aspects, the register has a dimension to receive the receiver. In some embodiments, the method includes performing a construction activity while the register vent guard is in the register. In some aspects, the method can include performing a cleaning activity while the register vent guard is in the register. In some aspects, the method can include performing a painting, sweeping, dusting, drywalling, mudding, or other activity in a room while the register vent guard is in the register in the room.

In some embodiments, a register vent guard kit can include a register vent guard in accordance with one of the embodiments, and at least one filter that is configured to be located in the chamber. In some aspects, the filter is packaged with the register vent guard. In some aspects, the filter is located outside of the chamber in a packaging. In some aspects, the kit can include a plurality of filters. In some aspects, the kit can include a plurality of register vent guards.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims. All references recited herein are incorporated herein by specific reference in their entirety.

1. A register vent guard comprising:
a body having:
a housing with a top wall, at least one housing side wall, and at least one bottom wall forming a chamber, the top wall being devoid of apertures, the at least one housing side wall having a plurality of side apertures, and the at least one bottom wall defining at least one shelf and a bottom aperture; and
a receiver extending from the at least one bottom wall, the receiver having at least one receiver side wall extending from the at least one bottom wall to a receiver bottom edge, the receiver forming a conduit that is fluidly coupled with the chamber; and
a filter located in the chamber.

2. The register vent guard of claim 1, wherein the body includes at least one of the following: four housing side walls; and/or four bottom walls;

3. The register vent guard of claim 1, wherein the body includes at least one of the following:
the top wall is connected to each housing side wall;
each housing side wall is connected to a bottom wall; and/or
each bottom wall is connected to a receiver side wall.

4. The register vent guard of claim 1, wherein the body includes at least one of the following:
the top wall is connected to each housing side wall through a bend;
each housing side wall is connected to a bottom wall through a bend; and/or
each bottom wall is connected to a receiver side wall through a bend.

5. The register vent guard of claim 1, wherein the body includes at least one of the following:
a gap between adjacent housing side walls such that the housing side walls are separate from each other;
a gap between adjacent receiver side walls such that the receiver side walls are separate from each other; and/or
a gap between adjacent bottom walls such that the bottom walls are separate from each other.

6. The register vent guard of claim 1, wherein the body includes at least one of the following:
a junction between adjacent housing side walls such that the housing side walls are joined together;
a junction between adjacent receiver side walls such that the receiver side walls are joined together; and/or
a junction between adjacent bottom walls such that the bottom walls are joined together.

7. The register vent guard of claim 6, wherein the junction between adjacent walls includes a weld, braze, a bend, a corner member, or combinations thereof.

8. The register vent guard of claim 1, wherein the plurality of side apertures have a combined cross-sectional profile area that is approximately the same or larger than a cross-sectional profile area of the bottom aperture.

9. The register vent guard of claim 1, wherein the conduit has a cross-sectional profile that is approximately the same as a cross-sectional profile area of the bottom aperture.

10. The register vent guard of claim 1, wherein the filter has a cross-sectional profile that is larger than the cross-sectional profile of the bottom aperture and/or conduit.

11. The register vent guard of claim 1, wherein at least one of the top wall, side wall, receiver side wall, bottom aperture, conduit, or chamber has a rectangular shape.

12. The register vent guard of claim 1, wherein:
the housing has a longitudinal axis aligned with a longitudinal axis of the conduit, wherein the housing has a lateral cross-sectional profile that is orthogonal with the longitudinal axis, the lateral cross-sectional profile being square, rectangular, circular, oval, or other polygon; and/or
the housing has a longitudinal axis aligned with a longitudinal axis of the conduit, wherein the housing has a longitudinal cross-sectional profile that is parallel with the longitudinal axis, the longitudinal cross-sectional profile being square, rectangular, trapezoidal, circular, oval, or other polygon.

13. The register vent guard of claim 1, comprising an overhang extending from the top wall relative to and over the at least one housing side wall.

14. The register vent guard of claim 1, wherein the body is a unitary member.

15. The register vent guard of claim 1, wherein the walls are joined by bends.

16. The register vent guard of claim 1, wherein the register vent guard is devoid of a weld or braze.

17. A method of making the register vent guard of claim 1, the method comprising:
providing a flat member;
cutting the flat member;
bending the flat member at a plurality of bend locations to form the register vent guard having a housing with:
a top wall, at least one housing side wall, and at least one bottom wall forming a chamber, the top wall being devoid of apertures, the at least one housing side wall having a plurality of side apertures, and the at least one bottom wall defining at least one shelf and a bottom aperture; and
a receiver extending from the at least one bottom wall, the receiver having at least one receiver side wall extending from the at least one bottom wall to a receiver bottom edge, the receiver forming a conduit that is fluidly coupled with the chamber.

18. The method of claim 17, comprising installing a filter in the chamber.

19. A method of using the register vent guard of claim 1 to inhibit contamination of a register, the method comprising:
providing the register vent guard of claim 1; and
inserting the register vent guard into a register.

20. A register vent guard kit comprising:
at least one register vent guard housing; and
at least one filter,
wherein the register vent guard housing includes:
a top wall, at least one housing side wall, and at least one bottom wall forming a chamber, the top wall being devoid of apertures, the at least one housing side wall having a plurality of side apertures, and the at least one bottom wall defining at least one shelf and a bottom aperture; and
a receiver extending from the at least one bottom wall, the receiver having at least one receiver side wall extending from the at least one bottom wall to a receiver bottom edge, the receiver forming a conduit that is fluidly coupled with the chamber.
